(19) United States
(12) Patent Application Publication
(10) Pub. No.: US 2008/0162801 A1
(43) Pub. Date: Jul. 3, 2008

(54) Series termination for a low power memory interface

(76) Inventors: Ripan Das, Beaverton, OR (US); Yuancheng C. Pan, Portland, OR (US); Steve Peterson, Sacramento, CA (US)

Correspondence Address: INTEL CORPORATION;c/o INTELLEVATE, LLC, P.O. BOX 52050, MINNEAPOLIS, MN, 55402, US

(21) Appl. No.: 11/647,641

(22) Filed: Dec. 29, 2006

(51) Int. Cl. G06F 13/38

(52) U.S. Cl. 711/105

(57) ABSTRACT

Series termination for a high speed interface, such as a DDR2 interface, is disclosed. In some embodiments series termination may be used instead of on-die termination to reduce power consumption on a platform.

### BACKGROUND

Data transfer rates between system memory and memory controllers and on other high-speed system interfaces are ever increasing. To improve signal integrity at these higher transfer rates, termination may be used in order to reduce signal reflections on the memory bus lines. However, traditional pull-up/pull-down on-die termination schemes can consume significant amounts of power for wide buses with frequent switching.

FIG. 1 illustrates the power consumption of a traditional on-die termination scheme. Because of the DC path to Vss and Vcc in a traditional termination scheme, current is always flowing through the pull-up resistor (R_{PU}) and the pull-down resistor (R_{PD}). This is illustrated by waveforms 102 and 104. Waveform 106 illustrates the voltage at a memory controller pad.

Thus, in a conventional on-die termination scheme, when the pad is high, the power consumed is equal to the current through R_{PD} (12.5 mA) times the voltage across R_{PD} (1.5 V) plus the current through R_{PU} (3.5 mA) times the voltage across R_{PU}, (0.4 V), or, approximately 20 mW. Similarly, when the pad is low, the power consumed is equal to the current through R_{PD} (3.5 mA) times the voltage across R_{PD} (0.4 V) plus the current through R_{PU} (12.5 mA) times the voltage across R_{PU} (1.5 V), or, approximately 20 mW. Thus, the average power dissipation for an on-die termination topology is approximately 20 mW.

### BRIEF DESCRIPTION OF THE DRAWINGS

A better understanding of embodiments of the present invention can be obtained from the following detailed description in conjunction with the following drawings, in which:

FIG. 1 is a graph illustrating power dissipation using an on-die termination scheme.

FIG. 2 is an illustration of a termination scheme according to some embodiments.

FIG. 3 is a graph illustrating power dissipation using a series termination scheme according to some embodiments.

FIG. 4 is an illustration of a package breakout routing according to some embodiments.

FIG. 5 is an illustration of a system according to some embodiments.

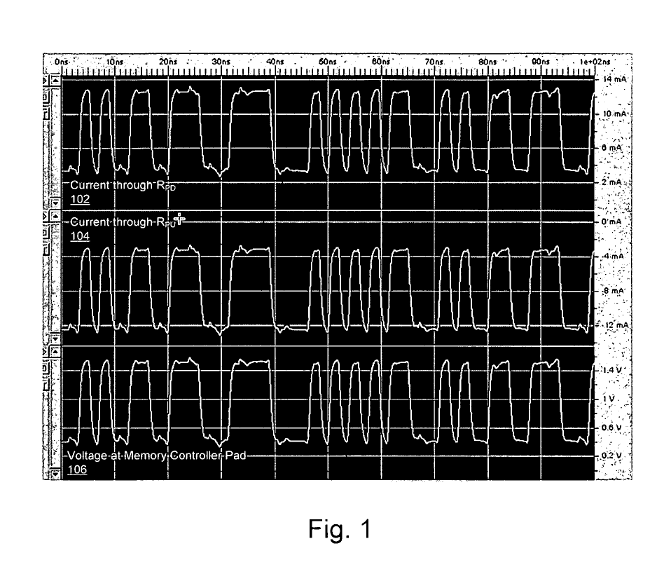

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed. For example, while embodiments set forth herein are described with respect to high speed DDR2 memory interfaces, it should be recognized that these embodiments may be applied to other high speed interfaces having impedance discontinuities as well.

In the following description and claims, the terms “include” and “comprise,” along with their derivatives, may be used, and are intended to be treated as synonyms for each other. In addition, in the following description and claims, the terms “coupled” and “connected,” along with their derivatives may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

Proper termination of input/output (I/O) signals aids in achieving required signal quality and timing margins. In some embodiments, signal termination may include only an on-motherboard series resistive element in place of on-die or on-board pull-up and pull-down resistors.

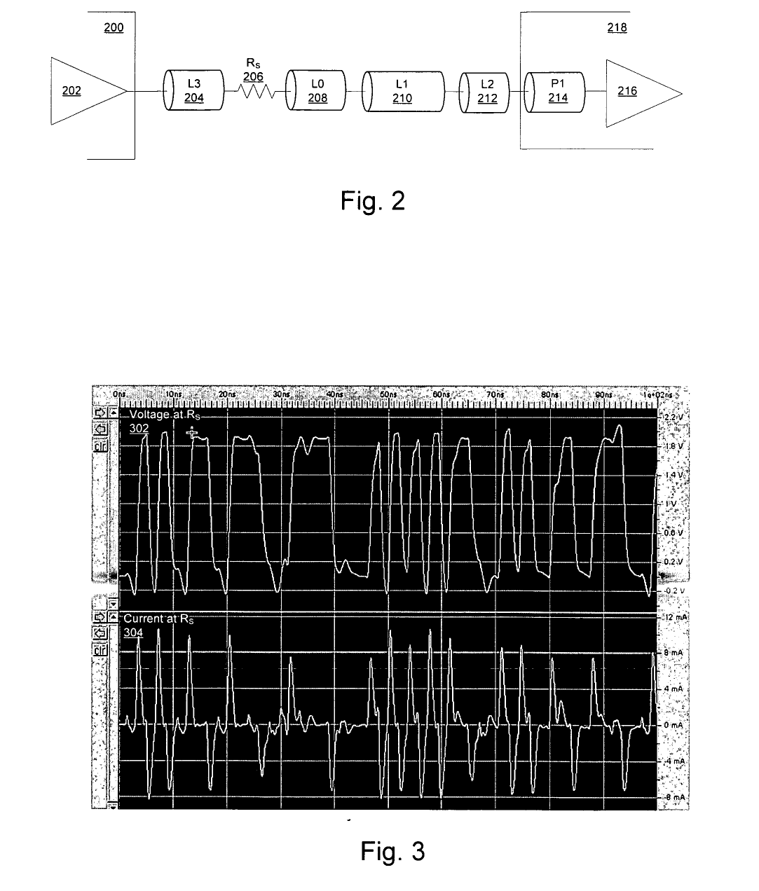

FIG. 2 illustrates a series termination scheme used for a high speed interface between a first device (200) and a second device (218) on a motherboard according to some embodiments.

The first device (200) may be a memory device, such as, but not limited to, a DDR2 memory device in some embodiments. The first device (200) may include at least one driver (202), which may be, for example, an output buffer. The driver may be capable of transmitting data at rates of 400 megatransfers per second (MTS) or greater.

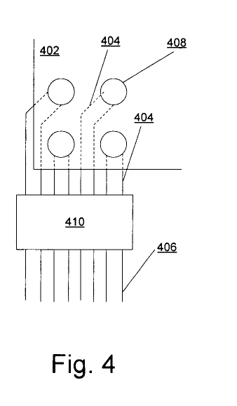

The first device may be on a motherboard, and may be coupled to a second device (218) via electrically conductive routing and a series resistive element (206). The series resistive element may be a resistor, or another passive element having similar electrical characteristics. The electrically conductive routing may be, for example, traces on a motherboard, and may include several portions or lengths (L3, L0, L1, L2), each of which may have different electrical characteristics. Length L3 (204) is the breakout routing into the first device package (200). The breakout routing is described in more detail below, in conjunction with FIG. 4.

A resistive element (206), Rs, is coupled to the driver (202) of the first device (200) in series via the breakout routing (204). The resistive element (206), Rs, is further coupled to a receiver (216) of a second device (218) in series via electrically conductive routing. Length L0 (208) of the electrically conductive routing may be a microstrip segment to connect the series resistive element (206) to the main motherboard routing, L1 (210). Breakout routing L2 (212) may connect the main motherboard routing to the second device (218). The second device's package may also have electrical characteristics such as impedance, as illustrated by P1 (214).

In some embodiments, the second device (218) may be a memory controller device. The second device may include at least one receiver (216), which may be, for example, an input buffer. The receiver may be capable of receiving data at rates of 400 megatransfers per second (MTS) or greater. In some embodiments, the second device may not include on-die termination. In this case, the only termination used for a high speed signaling interface may be series termination using a resistive element.

Thus, the series resistive element (206) may be coupled to a driver of a first device (200) and a receiver of a second device (218). In some embodiments, the series resistive element may be one of a plurality of resistors in a resistor pack.

The resistance of the series resistive element may be chosen so as to reduce impedance discontinuities between the driver (202) and the main motherboard routing (210). Thus, the driver impedance plus the resistance of the series resistive element may be approximately equal to the motherboard routing impedance (e.g. within several ohms) in some embodiments. By matching the impedance of the driver to the motherboard using a resistive element placed in series, reflections from the receiver may be absorbed by the resistive element.

An optimum value for the resistive element may be determined by performing simulations and sweeping across a range of values. The resistive element's value may be different on different platforms, depending on the driver impedance and the electrical characteristics of the motherboard routing. In some embodiments, the series resistive element may be approximately a 39 ohm series resistor.

Additionally, impedance discontinuities may be reduced by locating the series resistive element (206) in close proximity to the driver (202). This may require using short breakout routing lengths (204). Again, a maximum break-out routing length may be determined by performing simulations and sweeping across a range of breakout routing lengths. The maximum breakout routing length may be different on different platforms, depending on the driver impedance and the electrical characteristics of the motherboard routing. In some embodiments, the maximum breakout routing length (204) between the first device (200) and the series resistive element (206) may be 250 mils.

FIG. 3 illustrates the power consumption of a series termination scheme, such as that illustrated above in FIG. 2. Because there is no DC path to Vcc and Vss when using a series termination resistive element, the resistive element has only charging and discharging currents flowing through it. These currents do not flow for the whole period, as illustrated by waveform 304. Waveform 302 illustrates the corresponding voltage at the resistive element.

Thus, in a series termination scheme, when the pad is high, the power consumed is equal to the power through the series resistive element, or, 8 mA*0.2V*0.1=0.16 mW. Similarly, when the pad is low, the power consumed is equal to the power through the series resistive element, or, 12 mA*2.2 V*0.1=2.64 mW. Thus, the average power dissipation for this topology with series termination is approximately 2.8 mW. Using calculations performed by taking RMS (root mean square) values of simulated voltage and current waveforms a more precise value for average power dissipation with on-die termination is found to be approximately equal to 20.47 mW, and the average power dissipation using the series termination scheme is approximately equal to 3.5 mW. The power dissipation using a series termination scheme may therefore be significantly less that of a traditional on-die termination scheme.

FIG. 4 is an illustration of a package breakout routing from a memory package (402), or other device package including a driver, according to some embodiments. The package (402) may be coupled to a motherboard. Breakout routing (404) allows the signals to be routed from the package balls or pads (408) to main motherboard routing (406), or to another device, such as a resistor pack (410).

Series termination on a high speed data interface may be provided by a plurality of resistors in a resistor pack (410). The series termination resistor(s) may be coupled to the memory package via breakout routing (404), and may be further coupled to a device having at least one receiver, such as a memory controller device (not shown) by mother board routing (406).

When using a series termination scheme, the breakout routing traces (404) may have a maximum length imposed in order to ensure signal integrity. As described above, this maximum length may be determined on a platform-by-platform basis based on simulations. In some embodiments, the maximum length of the breakout routing (404) may be 250 mils. In some embodiments, the series resistive element(s) should be located as close to the memory package as possible.

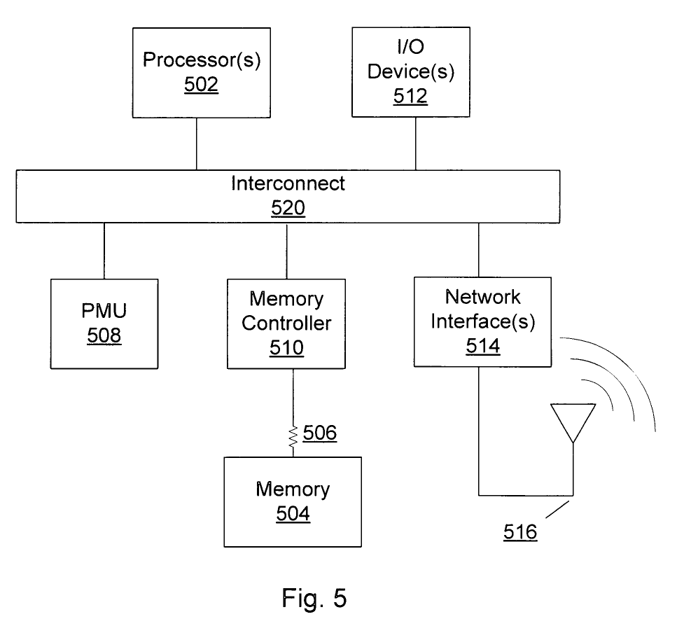

FIG. 5 is a block diagram of a system according to one embodiment. The system may include one or more processors (502), which may may be coupled to an interconnect (520). The processor (502) may be a microcontroller, one or more microprocessors, one or more multi-core microprocessors, a digital signal processor (DSP), or another type of controller. The system may be powered by a battery or may be powered with another power source, such as AC power, and may include a power management unit (508) coupled to the interconnect to perform power management functions for the system.

A variety of input/output (I/O) devices (512) may be coupled to the interconnect (520). The I/O devices may include items such as a display, keyboard, mouse, touch screen, or other I/O devices. A network interface (514) may also be coupled to the interconnect (520). The network interface (514) may be a wireless interface, and may enable cellular or other wireless communication between the system and other devices. In one embodiment, the wireless interface (514) may include an antenna (516), which may be a dipole antenna.

The system also includes memory controller (510) coupled to the processor via the interconnect. The memory controller may include a high speed receiver, as described above. The memory controller may be coupled to a resistive element, such as series resistor (506). The series resistor (506) may be coupled to a memory device (504), such as a DDR2 memory device, which includes a driver. The series resistor may be located in close proximity to the memory device, and may have a value selected to minimize reflections, as described above with respect to FIG. 2.

Thus, an apparatus and system for series termination are disclosed in various embodiments. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

I claim:

1. An apparatus, comprising:
a driver;
a resistive element coupled to the driver in series; and
a receiver coupled to the resistive element in series, wherein the driver is part of a first device on a motherboard, the receiver is part of a second device on the motherboard, and the resistive element is on the motherboard.

2. The apparatus of claim 1, wherein the first device is a memory device.

3. The apparatus of claim 2, wherein the memory device is a DDR2 memory device.

4. The apparatus of claim 2, wherein the memory device's driver is capable of is capable of transmitting data at a rate of 400 megatransfers per second (MTS) or greater.

5. The apparatus of claim 2, wherein the second device is a memory controller device.

6. The apparatus of claim 5, wherein the memory controller device does not include on-die termination.

7. The apparatus of claim 1, wherein the resistive element is coupled to the first device in series by electrically conductive routing, and wherein the electrically conductive routing between the resistive element and the first device is less than 250 mils in length.

8. The apparatus of claim 1, wherein the driver has a driver impedance, the resistive element has a resistance, and the motherboard has a motherboard routing impedance, and wherein the driver impedance plus the resistance is approximately equal to the motherboard routing impedance.

9. The apparatus of claim 8, wherein the resistive element is a resistor having a value of approximately 39 ohms.

10. The apparatus of claim 1, wherein the resistive element is a resistor within a resistor pack including a plurality of resistors.

11. A system, comprising:
an interconnect;
an antenna coupled to the interconnect;
a processor coupled to the interconnect;
a memory controller device coupled to the processor;
a series resistor coupled to the memory controller device; and
a memory device coupled to the series resistor.

12. The system of claim 11, wherein the series resistor is coupled to a driver in the memory device via breakout routing, and wherein the breakout routing is a maximum of 250 mils in length.

13. The system of claim 11, wherein the memory device is a DDR2 memory device.

14. The system of claim 13, wherein the memory controller device does not include on-die termination.

15. The system of claim 11, wherein the series resistor is coupled to a receiver in the memory controller device.
